(19) United States
(12) Patent Application Publication
(10) Pub. No.: US 2005/0281177 A1
(43) Pub. Date: Dec. 22, 2005

(54) High track density super resolution mo-rom medium

(75) Inventors: Coen Adrianus Verschuren, Eindhoven (NL); Bob Van Someren, 's-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/529,730

(22) PCT Filed: Sep. 12, 2003
(86) PCT No.: PCT/IB03/04006

§ 371 Date: Mar. 30, 2005

(30) Foreign Application Priority Data
Oct. 4, 2002 (EP) 02079130.7

(51) Int. Cl. G11B 7/24

(52) U.S. Cl. 369/275.1

(57) ABSTRACT

The invention relates to a MO-ROM medium with a small track width, wherein data is recorded at least on one side of a disk wherein a data side has on a substrate at least a recording layer wherein said data is recorded and at least a read-out layer to reproduce said data recorded in said recording layer during read-out. Recorded data is arranged within adjacent data tracks on said disk and a recording density within a data track is beyond the diffraction limited density of the focussing optics. By arrangement of the data tracks in groups of several adjacent data tracks wherein a track width within a data track group is at least less than the diffraction limit of the focussing optics and providing reference means for tracking a selected data track group with said read-out laser beam a specific data track of each data track group can be read-out by adjusting a proper offset value within the radial tracking unit.

The following invention is related to an high track density, i.e. having a small track width, Super Resolution MO-ROM medium according to claim 1, a method for read-out of the high track density Super Resolution MO-ROM medium according to claim 20, and an apparatus for read-out of the high track density Super Resolution MO-ROM medium according to claim 26.

Nowadays, optical disks are well known as electronic data storage media that can be read using a low-powered laser beam. Originally developed in the late 1960s, the first optical disk, created by James T. Russell, stored data as micron-wide dots of light and dark. A laser read the dots, and the data was converted to an electrical signal, and finally to audio or visual output. However, the technology didn't appear in the marketplace until the compact disk (CD) was introduced in 1982. Since then, there has been a constant succession of optical disk formats, first in CD formats, followed by a number of DVD formats.

At the very beginning of the successive development of optical disks, the greater control and focus possible with laser beams in comparison to tiny magnetic heads meant that more data could be written into a smaller space. This resulted in an increase of storage capacity with each new generation of optical media. Emerging standards, such as Blu-Ray, offer up to 27 gigabytes (GB) on a single-sided 12-centimeter disk. In comparison, a diskette, for example, can hold 1.44 megabytes (MB). Thus, optical disks offer a number of advantages over storage media using only magnetic techniques, for instance optical disks are inexpensive to manufacture and data stored on them is relatively impervious to most environmental threats, such as power surges, or magnetic disturbances.

As to the linear recording density of an optical disk, it depends strongly on the laser beam wavelength λ of a read-out optical system and the numerical aperture N.A. of its objective lens. As it regards the spatial frequency during signal reproduction, the order of (2·N.A.)/λ is the detectable limit. Accordingly, for realization of high density in the conventional optical disk, first way is to shorten the laser beam wavelength λ of the read-out optical system and/or to increase the numerical aperture N.A. of the objective lens. However, improvement in the laser wavelength X and the numerical aperture N.A. of the objective lens is limited.

In the recent years, so called Super Resolution techniques like the Magnetically induced Super Resolution (TSR), and Domain Expansion (DoiEx) techniques like the Magnetic Amplifying Magneto-Optical System (MAMMOS), and the Domain Wall Displacement Detection (DWDD) have been introduced. Such techniques allow read-out of information representing marks smaller than the diffraction limited spot size, i.e. λ/(2·N.A.), of the focussing optics. Now, by the use of Super Resolution techniques much higher linear densities can be applied than in conventional optical as well as magneto-optical recording.

In optical disk read-out the radial and vertical tracking of the data tracks containing recorded information is done by moving an optical read-out head. This optical read-out head is mounted in a so called actuator which enables axial and radial movements for focusing and radial tracking to compensate for movements of the spinning disk. In practice, axial movements of order of 1 mm can be expected. These movements are due to skew between the disk axis and the mechanical axis of rotation of the disk or e.g. warping of the disk. Lateral movements in the scanning direction are virtually unharmful because they can be balanced by adapting the progression of the digital signal clock. Radial movements are much more critical because they immediately lead to “track loss”. The amplitude of radial movements is mainly due to so-called disk eccentricity stemming from the mechanical tolerance on the dimension of the disk center hole, e.g. typically 50 μm, and the frequency of the movement is the fundamental frequency of the disk rotation. Additional radial movement is caused by vibrations of the shaft of the rotation motor and by the unroundness of the data track when the data track has the from of a spiral; these effects generally cause deviations of smaller amplitude but their frequency can be associated with higher multiplies of the fundamental rotation frequency. In a portable application, shocks will induce extra axial and radial movements with a still further extended temporal bandwidth.

Spontaneous movement of the data track relative to its average position needs to be counteracted. The approach, which has been chosen, from the very beginning of optical disk recording is to move the read-out optical system so that the optimum instantaneous read-out position is found again. Quick counteracting movements are made possible by strongly reducing the size and weight of the read-out optical system. In practice, a typical plastic read-out objective has a diameter of less than 6 mm and a mass of less than 50 mg. The 2D-movements are induced by electromechanical means, e.g. by attaching magnetic materials to the objective holder and actuating the objective with the aid of magnetic fields generated by currents through a set of nearby coils. At each moment, the correct direction of movement is controlled by optically derived error signals, which will drive the objective towards a mechanical set point corresponding to a position of optimum focus and on-track. Both a focus error signal and a radial error or tracking error signal are needed. Various methods for deriving optical error signals for tracking and focusing have been described in the literature together with their implementation in an optical disk player.

In the document U.S. Pat. No. 5,993,937 a read-only disk and a write-once disk recorded at high density having a magneto-optical film differing in coercive force depending an the information to be recorded disposed on a substrate is disclosed. This read-only and write-once disks, signals can be read employing only part of the irradiation beam, and thus Super Resolution reading is realized. In the document EP 848 381 A2 a magneto-optical recording medium exclusively for reproduction, a method of manufacturing the same and a method of reproduction are described. This magneto-optical recording medium in which a magnetic wall is displaced to hereby enlarge a magnetic domain so as to reproduce a micro magnetic domain indicative of information is effected, includes a non-magnetic substrate, a magnetic layer laminated on the substrate, and a projection-recess portion indicative of information formed on the surface of the substrate. The documents propose to make a MSR ROM and a DomEx ROM which provide a compatible, high capacity ROM format. Thereby, the manufacturing methods based on injection-molded substrates, i.e. easily reproducible for pre-recorded data, are introduced. However, the Super Resolution effect cannot be used directly to increase the storage density by a strong decrease of the track pitch.

As described in connection with the tracking a data track during read-out, a first problem to be solved is the limitation that track pitch must be large enough to give a sufficient tracking-error signal for the tracking electronics of the read-out system. This can be derived from precondition that the first order diffraction of a mark to be read must lie at least partly in the pupil of the read-out objective lens. For instance, by employing a short wavelength blue violet laser with a wavelength of λ=404 nm, the Blu-Ray Disk successfully minimizes its beam spot size by making the numerical aperture N.A.=0.85 on a field lens that converges the laser beam. In addition, by using a disk structure with a 0.1 mm optical transmittance protection layer, the Blu-Ray Disk diminishes aberration caused by disk tilt. This also allows for better disk read-out and an increased recording density. Thus, the Blu-Ray Disk's tracking pitch could be reduced to a practical limit of 320 mm. This contributes to the 27 GB high-density recording on a single sided disk.

A second important problem is cross-write. During recording on a MO-medium with e.g. Laser-Pulsed Magnetic Field Modulation (LP-MFM), the width of the recorded domains is around the Full Width at Half-Maximum (FWHM) intensity of the laser-beam focal spot, and cannot be reduced much without significantly degrading signal quality.

It is therefore a primary object of the present invention to provide a MO-ROM medium, which can reliably be read-out while having a narrower track pitch as conventional MO media and thus having an increased data capacity. Also is it an object to provide a method for read-out of the high-density track pitch MO-ROM and an apparatus in which the method for read-out of the MO-ROM is implemented. Moreover, it would be desirable as a copy limitation that data can be provided on such a MO-ROM to users while the data can be read-out with conventional read-out apparatuses, but additional information is provided on said MO-ROM which cannot be copied by conventional MO apparatuses with writing capability.

According to the present invention, a MO-ROM medium with small track width, is provided wherein data is recorded at least on one side of a disk. By using a read only memory MO medium the cross-writing problem is not a problem at all. With the Super Resolution ROM according to the present invention, the cross-write problem does not exist, since a master disk can be created with e.g. a direct write electron beam (e-beam) recorder with a much higher resolution than in optical systems. In this way, an e-bam recorder is used to define the pattern on a master disk. This master disk may then be used as a stamper in a nanoimprint lithography (nIL) system. In the nIL system, the pattern of the master stamper is transferred by pressing the master onto a substrate covered with e.g. a thin layer of polymer. The package is heated, leaving an imprint of the original and the substrate when the master stamper is removed. Another method may be using the master for injection molding as known from making of CD and DVD disks. It is possible to produce features down to 10 nm and therefore, structures under 50 nm can be formed for patterned-media applications. This could result in media capacities which exceed 100 Gbit/in² in surface density.

A data side of the MO-ROM according to the present invention has on a substrate at least a recording layer wherein data is recorded and at least a read-out layer to reproduce the data recorded in the recording layer during read-out. Recorded data is arranged within adjacent data tracks on the disk and a recording density within a data track is beyond the diffraction limited density, i.e. (2·N.A.)/λ, of the focussing optics. Further, the data tracks are arranged in groups of several adjacent data tracks, wherein track width within a data track group is made smaller than at least the diffraction limit λ/(2·N.A.) of the focussing optics. Reference means are provided for tracking a selected data track group with the read-out laser beam for each data track group. Thus, the tracking problem is advantageously solved by this combination of arranging several adjacent data tracks into a data track group and providing reference means for tracking a selected data track group with the read-out laser beam provided for each data track group, then a specific data track of a tracked data track group can be read-out by setting a proper offset value to the radial tracking means of a read-out apparatus.

As to the data track configuration, the MO-ROM disk may contain at least one data track having a spiral form running concentric with an increasing radius from the center of the disk to the outer edge of the disk. However, it is also possible that the MO-ROM disk contains a plurality of data tracks being concentric circles with increasing radii from the center of the disk to the outer edge of the disk. It should be noted that also a combination between data tracks having spiral form and data tracks having circular form could be applied.

Each of the data track groups may contain an odd number of data tracks. As to compatibility to conventional MO disk, the center or middle track would correspond to a track of a conventional MO disk. Therefore, advantageously, in case data is recorded only on the center track of each data track group the other data tracks of each data track group could contain additional information. The additional information may be used for copy limitation or copy protection. Moreover, this additional information could be read by a read-out apparatus according to the present invention, nevertheless copying would not be possible. Thus, a MO-ROM used for commercial software distribution could provide a reliable “dongle”-function for preventing software piracy.

In a first embodiment of the present invention the reference means are provided by local reference means between adjacent data track groups. As a first kind of the local reference means lands or grooves can be made within the substrate of the MO-ROM between each data track group, this supports an easier mastering. As a second kind of the local reference means a transition between a land and a groove within the substrate of the disk could be used, wherein each land and each groove contain one data track group. Width of a land and width of a groove may be equal. In such a substrate, a data track group comprising more than one data track is defined between the local reference means during the mastering process. During read-out of a specific data track of a tracked data track group, a proper offset value has to be set to the tracking control electronics which is for instance added to a push-pull error signal generated with reference to the center data track of the data track group and the local reference means. It has been found out that it is advantageous to make the width of a data track group in the range where tracking is robust, e.g. 400 nm with Blu-ray Disc Optics, i.e. λ=404 nm and N.A.=0.85.

In a second embodiment of the present invention time reference means are provided within each data track group, wherein the disk may have a flat substrate and the data track groups may be equally spaced. The time reference means may be embossed regions on the substrate within each of the data track groups. The embossed regions intermit each of the data track groups into data track group sections. A specific data track of a data track group can be tracked by setting a tracking offset value during read-out of an embossed region using for instance the differential time detection (DTD) method, while a tracking control is kept fixed between two embossed regions. The distance between the embossed regions must be chosen short enough to enable robust operation.

According to the Super Resolution technique which can be used together with a MO-ROM medium according to the present invention for read-out the applicable Super Resolution technique to be used is e.g. MSR, MAMMOS or DWDD. However, it should be noted that the man skilled in the art knows that the selected Super Resolution technique has to be considered in connection with the arrangement and materials of the different layers a MO medium is made of However, since the principle of the present invention is not restricted to a certain Super Resolution technique, these techniques will be not discussed herein in detail.

The method for read-out of the small track width MO-ROM according to claim 20 and the apparatus for read-out of a MO-ROM of the present invention according to claim 26 have the same advantages as described in context with the MO-ROM above.

The above and other objects, features and advantages of the present invention will become more clear from the following description of the preferred embodiments thereof, taken in conjunction with the accompanying drawings. It is noted that through the drawings same or functional equivalent parts may remain the same reference number. The terms “right”, “left”, “above” and “below” are used with respect to drawings orientated such that reference signs within the drawings can be normally read. All drawings are intended to illustrate some aspects and embodiments of the present invention. Apparatus and method steps are depicted in a simplified way for reason of clarity. Not all alternatives and options are shown and therefore, the present invention is not limited to the content of the accompanying drawings.

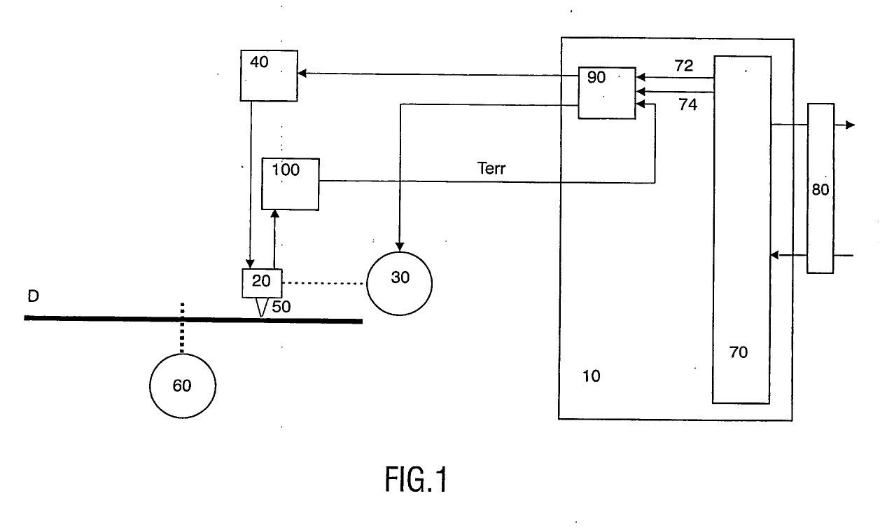

FIG. 1 is a schematic block diagram of a magneto-optical disk apparatus in which the present invention can be used;

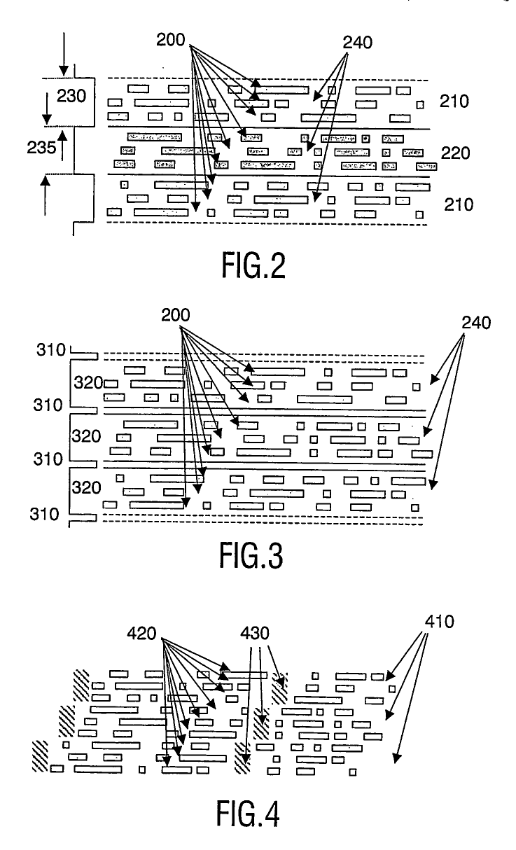

FIG. 2 shows a view from above on data track groups alternating contained in lands and grooves with equal width on the substrate of the MO-ROM;

FIG. 3 illustrates data track groups in grooves only, wherein adjacent data track groups are separated by a land ridge on the substrate; and

FIG. 4 depicts closely spaced data tracks on a flat substrate with embossed structures for DTD tracking.

FIG. 1 shows in principle by way of a schematic block diagram how the read-out method for the MO-ROM of the present invention can be applied to a magneto-optical read-out apparatus. However, it is noted that for clarity only those details are depicted within FIG. 1 which are needed for implementing the present invention into a magneto-optical disk apparatus.

The magneto-optical disk apparatus of FIG. 1 has a controller 10 and an optical read-out head 20, also called optical pickup unit. The optical read-out head 20 is moved by a motor 30 for moving and positioning the head 20 in the radial direction of the optical disk D. A lens actuator 40, e.g. a Voice Coil Motor (VCM), is also installed in the head 20, also called tracking actuator, and moves an objective lens of the head 20 for forming a read-out laser beam 50 as an image onto the surface of the disk D within a range of a selected data track group and thus, controls a laser beam position. During a data track group seeking operation, when the number of data track groups to be skipped is large, the optical read-out head 20 is moved via the motor 30. While, in a selected data track group when the number of data tracks to be skipped is small the read-out laser beam 50 is moved by the lens actuator 40. A focusing actuator in the head 20 moves the objective lens provided for the head 20 in the direction of the optical axis for adjusting a focal spot of the read-out laser beam 50 so that a specific beam spot is formed as an image onto the disk medium surface. A photo detector inside the head 20 receives reflect light caused by the irradiation of the laser beam 50 to the medium surface of the optical disk D. As a photo detector, e.g. a 4-split photo detector can be used.

For generating a tracking signal Terr and focusing error signal, analyzing of light reception signals from the four light-receiving sections of the 4-split photo detector is performed. A read-out laser diode in the optical read-out head 20 generates the read-out beam 50 for the read-out operation. According to the invention, since the optical MO-ROM disk having at least a recording layer and a read-out layer on a substrate according to a magnetic induced Super Resolution technique is used as an magneto-optical disk, an electromagnet may also be provided for generating the proper and applicable bias external magnetic field for reproduction of recorded data recorded on the magneto-optical disk D.

A spindle motor 60 rotates the MO-ROM disk D of the optical disk apparatus. When the optical disk apparatus of the invention is to be used for an optical disk of 3.5 inch enclosed in a cartridge, the MO-ROM disk is chucked with a rotary axis of the spindle motor by loading the cartridge to the apparatus. The spindle motor 60 is activated after completion of the chucking, thereby rotating the MO-ROM disk at a predetermined rotating speed.

As to the controller 10 of the optical disk apparatus, functions of the controller 10 may be realized by a program control of a microprocessor or a digital signal processor. A master control unit 70 is provided for the controller 10, which transmits and receives commands, data, or like to/from an upper optical disk control unit through an interface control unit 80. After completion of the initialization diagnosing operation at the time of the turn-on of the power source, when receiving an access request from an upper optical disk control apparatus through the interface control unit 80, the master control unit 70 performs the seeking operation for a selected data track group by setting a data track group selection signal 72 and a proper and appropriate offset value 74 to the tracking control unit 90 whereby in the selected data track group a specific data track can be read-out. The tracking control unit 90 controls the head 20 by steering the motor 30 and the lens actuator 40 so as to be positioned to the specific data track group, while the tracking of a specific data track of the selected data track group is performed in accordance with the reference means provided to each data track group. Thus, the head 20 performs the read-out operation. The tracking control unit 90, a focusing control unit, a laser emitting power control unit, a bias magnet control unit are also provided for the master control unit which are not shown.

A tracking error signal is generated by a tracking error detecting circuit 100 from the signal detected by the photo detector and supplied to an A/D converter. Based on an output signal of the A/D converter, the tracking control unit 90 executes the seeking operation and the tracking control unit keeps the read-out laser beam 50 on-track after completion of the seeking operation. An output of the tracking control unit 90 drives the motor through a D/A converter and a driver, and drives the lens actuator 40 through a D/A converter and a driver.

During read-out, conventional push-pull tracking can be used. The different data tracks within a selected data track group are read-out by providing the proper and applicable tracking offset 74 to the tracking control unit 90 by the master control 70. It has been experienced that for stable tracking, offsets of ±50% are no problem. Thus, in the magneto-optical read-out apparatus of the present invention, the Super Resolution effect can be fully exploited in both tangential and radial direction, so that a very large increase in storage density can be achieved. Since the resolution is easily better than 100 nm, so that effective track widths of around 100 nm can be used instead of 320 nm for the above described Blu-Ray disk system. For compatibility with conventional (rewritable) Super Resolution media as well as copy limitation, it may be beneficial to use an odd number of data tracks for each data track group, where the center or middle track, i.e. offset is zero, can be read by all recorders/players and thus also be copied, while the neighboring tracks in the same data track group could contain additional information which can not be copied directly to another disk. Thus, there is provided a efficient way for copy limitation, conditional access or digital rights management.

A focusing error detection signal obtained by a focusing error detecting circuit based on the detection signal of the photo detector is supplied to an A/D converter. An output signal of the A/D converter is supplied to the focusing control unit. The focusing control unit drives the focusing actuator through a D/A converter and a driver, and controls the laser beam to have a specific focal spot diameter.

FIG. 2 and FIG. 3 show as a first and second embodiment of a MO-ROM providing a first solution of the tracking problem according to the present invention, wherein local reference means are provided between adjacent data track groups 240. A grooved substrate, i.e. the substrate comprises grooves 210 and lands 220, is used with a data track group pitch in the range where tracking is robust, e.g. 400 nm with Blu-ray Disc Optics (λ=404 nm and N.A.=0.85). In such a substrate, more than one data track 200 is defined in each land 220 and each groove 210 building a data track group 240 during the mastering process. Thus, both land 220 and groove 210 are used, each with a equal width 230, 235, which correspond to the data group pitch.

As shown in FIG. 3 it is also possible to use a wide land 320 with several data tracks 200 building a data track group 240 and a narrow groove 310 as local reference means for tracking purposes. It would be also possible to use a wide groove with several data tracks building a data track group and a narrow land as local reference means for tracking purposes (not shown in the FIG.).

FIG. 4 illustrates a third embodiment of a MO-ROM providing a second solution of the tracking problem according to the present invention, wherein time reference means are provided within each data track group 410. Here a flat substrate with closely spaced data tracks 420 is used, i.e. the same as the first solution, but without a land/groove structure. There are provided embossed areas 430, i.e. shaded area in FIG. 4, for tracking a designated data track group 410 by using the differential time detection method (DTD). Between the embossed areas 430, the radial tracking loop of the tracking control unit is kept fixed. The distance between the embossed regions is made short enough to enable robust operation.

Finally, it should be noted that like in Two Dimensional Optical Storage (TwoDOS), a correlation between adjacent data tracks can also be taken into account, e.g. to improve coding efficiency or to minimize cross-track effects from strayfield or exchange coupling by using an optimized recording strategy.

With the present invention a MO-ROM medium with a small track width has been introduced, wherein data is recorded at least on one side of a disk wherein a data side has on a substrate at least a recording layer wherein said data is recorded and at least a read-out layer to reproduce said data recorded in said recording layer during read-out. Recorded data is arranged within adjacent data tracks on said disk and a recording density within a data track is beyond the diffraction limited density (2·N.A.)/λ of the focussing optics. Moreover, it has been shown that by arrangement of the data tracks in groups of several adjacent data tracks wherein a track width within a data track group is at least less than the diffraction limit λ/(2·N.A.) of the focussing optics and by providing reference means for tracking a selected data track group with said read-out laser beam a specific data track of each data track group can be read-out when a proper offset value within the radial tracking unit is adjusted accordingly.

It is noted that the present invention is not restricted to the above preferred embodiments but can be applied in any data storage media and a respective data storage read-out apparatus in which a cross-talk during read-out of the stored data can be avoided by providing a robust radial tracking of the read-out system on a data track to be read-out, e.g. using the arrangement of recorded data according to the present invention. The preferred embodiments may thus vary within the scope of the attached claims. Although the present invention has been described herein with reference to particular embodiments thereof, a latitude of modifications, various changes and substitutions are intended in the foregoing disclosure, and it will be appreciated that in some instances some features of the invention will be employed without a corresponding use of other features without departure from the scope of the invention as claimed within the claims.

1. A MO-ROM medium with small track width, wherein
data is recorded at least on one side of a disk;
a data side has on a substrate at least a recording layer wherein said data is recorded and at least a read-out layer to reproduce said data recorded in said recording layer during read-out;
said recorded data is arranged within adjacent data tracks on said disk; and
a recording density within a data track is beyond the diffraction limited density (2 N.A./λ) of the focussing optics,
characterized in that
said data tracks are arranged in groups of several adjacent data tracks;
said track width within said data track groups is smaller than at least the diffraction limit (λ/2 N.A.) of the focussing optics; and
reference means for tracking a selected data track group with said read-out laser beam are provided for each data track group.

2. A MO-ROM medium according to claim 1, wherein said disk contains at least one data track group having a spiral form running concentric with an increasing radius from center of said disk to the outer edge of the disk.

3. A MO-ROM medium according to claim 1, wherein said disk contains a plurality of data track groups being concentric circles with increasing radii from center of the disk to the outer edge of the disk.

4. A MO-ROM medium according to claim 1, wherein said reference means are provided by local reference means between adjacent data track groups.

5. A MO-ROM medium according to claim 4, wherein said local reference means are lands and/or grooves within the substrate of said MO-ROM.

6. A MO-ROM medium according to claim 5, wherein said local reference means are provided by a transition between a land and a groove within said substrate of said disk and each land and each groove contain one of said data track groups.

7. A MO-ROM medium according to claim 6, wherein a width of said lands and a width of said grooves are equal.

8. A MO-ROM medium according to claim 1, wherein each of said data track groups contains an odd number of data tracks.

9. A MO-ROM medium according to claim 4, wherein a specific data track of a data track group is selected for read-out by an offset value added to a push-pull error signal generated with reference to a center data track of said data track group and said local reference means.

10. A MO-ROM medium according to claim 9, wherein data is recorded only in said center track of each of said data track groups.

11. A MO-ROM medium according to claim 10, wherein at least one of the other data tracks of at least one of said data track groups contains additional information, wherein said additional information provides for e.g. copy limitation, conditional access or digital rights management.

12. A MO-ROM medium according to claim 1, wherein time reference means are provided within each data track group.

13. A MO-ROM medium according to claim 12, wherein said time reference means are embossed regions on said substrate within each of said data track groups.

14. A MO-ROM medium according to claim 13, wherein said embossed regions intermit each of said data track group into data track group sections.

15. A MO-ROM medium according to claim 13, wherein a specific data track of a data track group is selected by setting a offset value during read-out of an embossed region using the differential time detection (DTD) method, while tracking control is kept fixed between two embossed regions.

16. A MO-ROM medium according to claim 12, wherein said disk has a flat substrate and said data track groups are equally spaced.

17. A MO-ROM medium according to claim 1, wherein for read-out a Super Resolution technique is used like MSR, MAMMOS or DWDD.

18. A MO-ROM medium according to claim 1, wherein said disk is produced by injection molding or by photopolymer replication.

19. A MO-ROM medium according to claim 18, wherein the information pattern is defined in the injection molding master or the replication layer by a high-resolution lithography technique, like an electron-beam writer.

20. A method for read-out of a small track width MO-ROM with data recorded in a adjacent data tracks wherein a data track has a recording density beyond the diffraction limited density (2 N.A. /λ) of the focussing optics and a predetermined number of adjacent data tracks are arranged in data track groups in which track width is smaller than at least the diffraction limit λ/2 N.A. of the focussing optics and reference means are provided for each data track group for tracking a selected data track with the read-out laser beam, comprising the steps:
identifying said reference means on said MO-ROM medium to be read-out;
selecting a specific data track group on said MO-ROM medium for read-out; and
setting an offset value according to said reference means to tracking means for keeping said read-out laser beam tracked on a specific data track within said selected data track group to be read-out.

21. A method for read-out of a MO-ROM with small track width according to claim 20, wherein said reference means are local reference means between adjacent data track groups.

22. A method for read-out of a MO-ROM with small track width according to claim 20, wherein during read-out of a data track conventional push-pull tracking is used.

23. A method for read-out of a MO-ROM with small track width according to claim 20, wherein said reference means are embossed time reference means within each data track group intermitting each data track into data track group sections.

24. A method for read-out of a MO-ROM with small track width according to claim 23, wherein during read-out for tracking a selected data track group the differential time detection method is used with respect to said embossed time reference means.

25. A method for read-out of a MO-ROM with small track width according to claim 20, wherein said tracking means are a radial tracking electronics for keeping said read-out laser-beam on a specific data track to be read-out and said set offset value is a tracking offset to adjust said tracking electronics.

26. An apparatus for read-out of a small track width MO-ROM medium with at least a recording layer for recorded data and a read-out layer to reproduce said recorded data in said recording layer on a substrate, wherein data is recorded at least on one data side of a disk within adjacent data tracks wherein first a recording density within a data track is beyond the diffraction limited density (2 N.A./λ) of the focussing optics and second said data tracks are arranged in groups of several adjacent data tracks with an individual track width of at least less than the diffraction limit λ/2 N.A. of the focussing optics and local and/or time reference means for keeping said read-out laser beam tracked on a selected data track group are provided for each data track group comprising:
a read-out unit for read-out of said data recorded in said recording layer of said small track width MO-ROM medium at said small track width and at said recording density beyond the diffraction limited density (2 N.A./λ) of the focussing optics;
a tracking unit for keeping said read-out laser-beam tracked on a selected data track group containing a specific data track to be read-out; and
a control unit for supplying an offset value to said tracking unit corresponding to a data track to be read-out according to said local and/or time reference means provided by said MO-ROM.

27. An apparatus according to claim 26, wherein said control unit adds a offset value to a tracking error signal derived from local reference means arranged between adjacent data track groups.

28. An apparatus according to claim 26, wherein said control unit sets a offset value to a tracking error signal derived from time reference means arranged within each data track group intermitting each data track group in data group sections.
